(19) United States
(12) Patent Application Publication
(10) Pub. No.: US 2014/0229255 A1
(43) Pub. Date: Aug. 14, 2014

(54) INCENTIVE-BASED TRAFFIC MANAGEMENT

(71) Applicant: INRIX, INC., Kirkland, WA (US)

(72) Inventors: Christopher L. Scofield, Seattle, CA (US); Scott Marshall Sedlik, Mercer Island, WA (US)

(73) Assignee: INRIX, Inc., Kirkland, WA (US)

(21) Appl. No.: 13/763,433

(22) Filed: Feb. 8, 2013

(51) Int. Cl. G06Q 30/02

(52) U.S. Cl. CPC G06Q 30/0207
USPC 705/14.21; 705/14.1

(57) ABSTRACT

One or more techniques and/or systems are provided for managing traffic, such as road traffic. When a traffic authority indicates a desire to reduce load on a route or within a particular geographic zone, an offer is provided to a group of one or more users. The offer is indicative of a reward provided to the users in return for avoiding the route during a specified time window. If a user accepts the offer, movement of the user is monitored during the specified time window to verify that the user avoided the route, in which case the reward is provided to the user. If an insufficient number of offers are accepted (e.g., to achieve a desired load reduction), the offer communicated to the users is adjusted (e.g., to increase an incentive for users to accept the offer). Outstanding offers are revoked once a sufficient number of offers are accepted (e.g., to achieve the desired load reduction).

### BACKGROUND

As the number of vehicles on the road continues to increase, traffic authorities, such as local, state, and/or national transportation departments have struggled to balance road capacity with demand. For example, some bridges built decades ago have been reconfigured to support a higher capacity due to lack of infrastructure funds to build new bridges. Additionally, peak demand on a road may be substantially greater than average demand. For example, during rush hours and/or local events, demand on a road may exceed average demand by a factor of 10 or more. While it is desirable for a road to be constructed that supports peak demand, budget constraints may cause traffic authorities to design roads that are configured to support less vehicles than peak demand. Additionally, even where a road is designed to support peak demand, slow moving vehicles, accidents, construction, and/or weather conditions, for example, may at times reduce road capacity below peak demand, creating traffic congestion and/or delayed travel times.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques are described herein for incentivizing users, such as consumer or commercial drivers, to avoid particular routes (e.g., road segments, highways, geographic regions, etc.) during a specified time window and/or for encouraging users to travel particular routes during the specified time window. By way of example, a reward may be offered to a user in exchange for the user agreeing to avoid a congested route to facilitate reducing load along the congested route. As other examples, a reward may be offered to a user in exchange for the user agreeing to avoid a heavily polluted route and/or agreeing to avoid a route along which there is limited parking available. In still other embodiments, a reward may be offered to a user in exchange for the user agreeing to travel along a less congested route, a less polluted route, a route proximate ample parking, etc. In this way, an entity can actively manage movement of vehicles/users to achieve a desired result. Movement of users that accept the offer may be tracked during the specified time window, and users that avoid a route as specified in the offer or that travel a route as specified in the offer may be rewarded with the reward (e.g., such as points to apply towards gift cards, license registration fees, etc.).

In some embodiments, an offer made to a user is modified dynamically as a function of offers that have been accepted by other users. By way of example, a traffic authority may determine that it is desirable to decrease traffic volume along a route by 200 vehicles between 5 pm and 6 pm. To achieve this desired load reduction, an initial offer may be communicated to 500 users (e.g., believing that at least some users will reject the offer). The initial offer may provide for a reward of 100 points to avoid the route. If a number of users that accept the offer is less than a number that is needed to decrease traffic along the route by 200 vehicles, the offer may be updated to provide for a reward of 200 points to avoid route. The number of points may continue to increase until a desired number of users have accepted the offer, at which time the offer may be revoked from those users who have yet to accept (e.g., where revocation may merely comprise deactivation of the offer and/or some other type of inability of the offer to be accepted). In this way, an auction environment is created, where users balance the reward with the risk of losing the offer (e.g., and thus the reward) when deciding whether to accept or reject an offer.

In still other embodiments, users to whom it is desired to communicate an offer (e.g., offer candidates) are identified from a pool of users. For example, not every driver in a city is going to travel a route during a specified time window. Accordingly, prior driving habits and/or other information about respective users may be utilized to determine, for respective users, a probability that the user will travel the route during the specified time window. Based upon such information, users to whom to communicate the offer may be identified. For example, users having a highest probability of traveling the route during the specified time window may be identified as candidates for the offer. As another example, users that have an option to take an alternate route (e.g., without substantially increasing travel time and/or distance) may be identified as candidates for the offer. As yet another example, users that are likely to have flexibility with respect to travel time may be identified as candidates for the offer (e.g., because the users may be able to travel the route at a time when the route is less congested).

The following description and annexed drawings set forth certain illustrative aspects and implementations. These are indicative of but a few of the various ways in which one or more aspects may be employed. Other aspects, advantages, and/or novel features of the disclosure may become apparent from the following detailed description when considered in conjunction with the annexed drawings.

### DESCRIPTION OF THE DRAWINGS

FIG. 1 illustrates an example environment for estimating or monitoring traffic congestion along a route.

FIG. 2 illustrates an example environment for actively managing present loads and/or expected future loads along a route.

FIG. 3 illustrates an example traffic management system.

FIG. 4 illustrates an example environment describing how one or more users may be incentivized to avoid a route such as via a traffic management system.

FIG. 5 illustrates a flow diagram of an example method for traffic management.

FIG. 6 is an illustration of an exemplary computer-readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Today, traffic authorities, such as government entities and/or private organizations acquire road traffic-related data from numerous fixed and mobile sensors. Such data can be mined to understand the locations of bottlenecks, to understand scenarios that create bottlenecks (e.g., such as events, weather conditions, etc.), and/or to manage loads along one or more routes. However, few options are available for traffic authorities to divert traffic to other routes to alleviate loads along one or more routes. For example, options presently available include using billboards and/or radio alert systems to notify users to avoid a specific route. While these options are useful, users often do not get the alerts until it is too late to avoid the congestion. Moreover, the alerts typically are not user specific. For example, the alerts do not suggest an alternate route specifically tailored for a particular user.

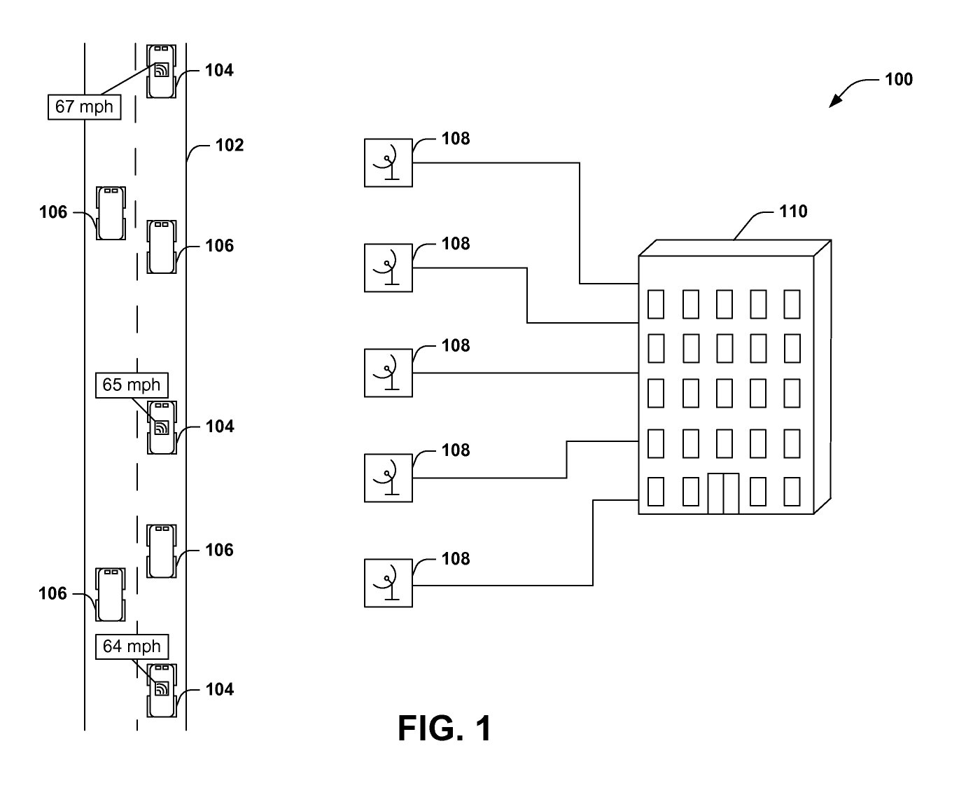

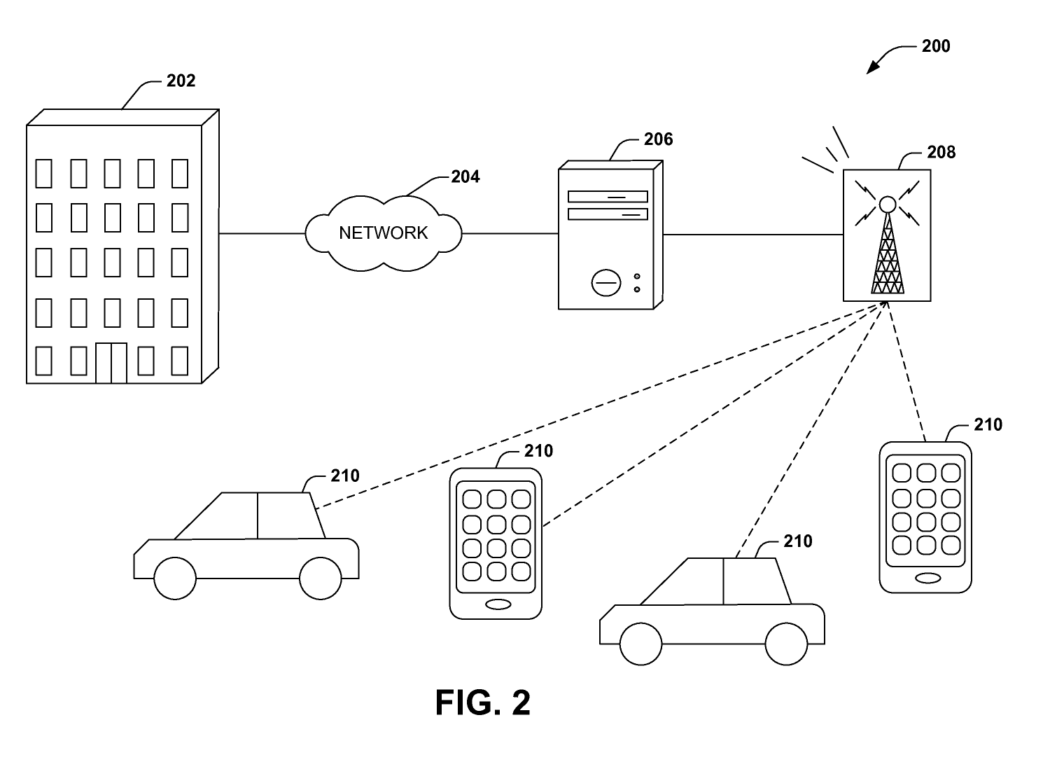

It will be appreciated that while a traffic authority is referenced herein, a traditional traffic authority may not be required. For example, a system (e.g., 206 in FIG. 2) may perform all the functions, operations, etc. of a more traditional traffic authority (e.g., 110 in FIG. 1, 202 in FIG. 2, etc.). Such a system or service may, for example, determine traffic volume and perform functions that a more traditional (e.g., governmental) traffic authority may otherwise perform. Stated another way, such a system or service may be regarded as serving one of the roles of a more traditional traffic authority. A traffic authority may thus generally refer to an entity whose responsibilities include traffic monitoring, traffic management, and/or other traffic related duties. For example, a more traditional traffic authority may be a government agency responsible for monitoring one or more roads and/or maintaining such roads. As another example, however, the traffic authority may be a private organization responsible for monitoring or maintaining a road, such as a toll-road that has been leased by the private organization. As another example, the traffic authority may be a company who collects traffic data for the purpose of providing route information and/or providing navigational information to one or more customers. Accordingly, a traffic authority as referenced herein generally refers to an entity concerned with, among other things, monitoring, managing, controlling, governing, etc. traffic along a route, for example (e.g., regardless of whether the traffic authority is a more traditional (e.g., governmental) entity or a less traditional (e.g., non-governmental or private) entity).

Accordingly, among other things, one or more systems and/or techniques for bettering managing loads and/or diverting traffic (e.g., to reduce congestion, reduce/alter pollution levels along one or more routes, navigate traffic away from areas where parking is limited and to regions where parking is ample, etc.) are provided for herein. In some embodiments, a system is configured to interface with a traffic authority responsible for managing loads on a route or set of routes. The traffic authority may request that the system reduce the present volume of a route and/or an expected future volume of a route by a desired load reduction (e.g., by a desired number of vehicles). Using this information, the system may generate one or more offers to be provided to a set of users (e.g., where a same offer may be provided to a plurality of users and/or some users of a plurality may receive an offer that differs from the offer provided to other users of the plurality). In some embodiments, the offer(s) may provide a reward to avoid the route during a specified time window. The reward may or may not have direct monetary value. The value (e.g., such as a number of points redeemable for gift cards, cash discounts, etc. or other value related to the ranking of a user in a user community) of the reward may escalate until a desired number of users accept the offer, at which time the offer may be revoked from users that had not yet accepted.

It may be appreciated that while specific reference is made herein to managing road traffic, the techniques and/or systems may also find applicability to other forms of transportation. For example, the techniques and/or systems described herein may be utilized to manage congestion on trains and/or buses by offering a reward to customers in exchange for the customers riding a less congested train/bus and/or riding on a train/bus at a different time, for example.

Moreover, while reference is made herein to managing traffic to facilitate reducing loads along a route and/or shifting loads between routes in an effort to reduce congestion, the techniques and/or systems described herein may also find applicability to the management of traffic for other purposes besides congestion reduction. For example, an entity responsible for monitoring and/or managing pollution, may desire to incentivize drivers to avoid certain routes (e.g., urban corridors, city streets, etc.) during specified time windows and/or may incentivize drivers to travel particular routes (e.g., where readings from sensors are indicating low carbon dioxide concentrations, low particulate matter levels, etc.). In such an embodiment, the entity responsible for monitoring and/or managing pollution may play the role of traffic authority and may collect pollution information for sensors along one or more routes. Based upon the collected information, the entity may identify instances where it is desirable to incentive drivers to avoid a route or where is it desirable to incentive drivers to travel an alternative route.

As another example, an entity responsible for monitoring and/or managing parking conditions may desire to incentive drivers to avoid certain routes where parking is limited and/or to encourage drivers to travel routes where ample parking is available. In such an embodiment, the entity responsible for monitoring and/or managing parking conditions may play the role of traffic authority and may collect information regarding the availability of parking (e.g., such as from parking garages, meters, or other devices configured to report parking conditions). Using the collected information, the entity may identify routes where parking is ample and may desire to incentivize users to travel such routes (e.g., to navigate users to available parking locations and discourage users from traveling routes where parking is limited—which may lead to congestion on streets while drivers are slowing down to seek parking).

FIG. 1 illustrates an example environment 100 for estimating or monitoring traffic congestion along a route 102, such as along a portion of a highway, based upon information provided by reporting devices 104. Such estimates may be utilized by a traffic authority 110 (e.g., whether a more traditional (e.g., governmental) entity or not) to estimate present or future load on the route and/or to manage loads on the route. For example, the collected information may be utilized to estimate a load on the route during a future event and/or at a future time. Moreover, the collected information may be utilized to determine a desired load reduction for the route 102 during a specified time window, such as during rush hour, during a concert event, and/or during a professional athletic event, for example. In other embodiments, the reporting devices may include pollution sensors (e.g., configured to measure CO₂ concentration, sulfur concentrations, particulate matter, etc.) and/or parking sensors (e.g., configured to measure the availability of parking), which report information regarding pollution and/or parking along a route to the traffic authority 110.

In the example environment 100, the reporting devices 104 are vehicles respectively comprising a wireless communication device and configured to transmit status information, such as speed, vehicle headway, etc. to a receiver 108. In other embodiments, the report devices 104 may comprise, among other things, mobile phones, tablets, laptop computers, media devices, two-way radios, and/or navigation devices. In still other embodiments, the reporting devices 104 may be dedicated traffic monitoring sensors positioned along the route 102, such as radar sensors, in-road electromagnetic sensors, and/or laser sensors configured to measure a speed of vehicles, monitor vehicle headway (e.g., distance and/or time between vehicles passing a fixed point), and/or count a number of vehicles per unit time. In still other embodiments, video cameras, for example, may be positioned along the route 102 to monitor traffic flow. It may be appreciated that not all vehicles and/or devices may be configured to report status information. For example, some vehicles 106 may not comprise the capability to report information and/or the capability may be disabled (e.g., such as by a user for privacy).

In the illustrated embodiment, receivers 108 are positioned at various locations proximate the route 102 and are configured to receive signals from reporting devices 104 within a particular geographic region. By way of example, a first receiver 108 may be configured to receive signals from reporting devices 104 proximate (e.g., traveling) a first span of the route 102 and a second receiver 108 may be configured to receive signals from reporting devices 104 proximate a second span of the route 102. In this way, the reported information can be correlated to a particular stretch of the route 102. In other embodiments, the reported information may include location information to enable such a correlation. It will be appreciated that one or more of the receivers 108 may be configured to wirelessly receive information from the reporting devices 104 (e.g., via radio broadcast, WiFi, Internet, satellite, etc.). Additionally and/or alternatively, one or more of the receivers 108 may be configure to directly receive information from the reporting devices, such as where the reporting devices 104 are dedicated traffic monitoring sensors and/or are hardwired to the receivers 108, for example.

The number of vehicles counted per unit time is typically indicative of traffic volume along a route (e.g., and thus traffic congestion), although speed and/or vehicle headway may also be used directly or indirectly for traffic volume estimation. The volume along a span of the route 102 may be affected by traffic accidents, road hazards (e.g., a pothole, debris, etc.), weather conditions (e.g., heavy rain, ice, or hail), local events, construction, time-of-day, etc.

Status information, such as speed, headway, vehicle count, pollution, parking availability, etc. received by respective receivers 108 from the reporting devices 104 may be transmitted to a traffic authority 110, such as a government entity and/or private organization that monitors and/or manages volume along the route 102 (e.g., for the purpose of infrastructure upgrades, route navigation, etc.). Over time, the traffic authority 110 may collect information that assists the traffic authority 110 in predicting future loads along the route 102, predicting pollution levels, predicting parking availability, assists the traffic authority 110 in identifying bottlenecks, etc. Moreover, the collected information may assist the traffic authority 110 in determining whether to divert vehicles from the route 102 and/or a number of vehicles to divert from the route 102 to lessen strain along a route (e.g., at times when demand approaches capacity or is expected to approach capacity, at times when pollution along the route exceeds a desired threshold, at times when parking availability along the route is limited, etc.).

FIG. 2 illustrates an example environment 200 for actively managing present loads and/or expected future loads along a route (e.g., 102 in FIG. 1). More particularly, the example environment 200 provides for a traffic management system 206 configured to incentivize users to avoid the route during a specified time window, such as when the route is expected to be at, near, or over capacity. The system 206 may also be configured to incentivize users to avoid the route when the route is expected to have undesired pollution levels (e.g., if traffic is not actively re-routed) and/or when parking availability is expected to be limited along the route (e.g., such as during a special event).

The system 206 is operably coupled to a traffic authority 202 (e.g., 110 in FIG. 1) via a network 204 (e.g., LAN, WLAN, cellular, wireless, etc.) and is configured to receive information from the traffic authority 202. As an example, the system 206 may receive traffic data, pollution data, parking availability data, etc. (e.g., in raw form as provided from the receivers 108 and/or in an aggregated form) from the traffic authority 202. Although not illustrated, the system 206 may also or instead receive information from vehicles directly (e.g., without the aid of another party). By way of example, the system 206 may be in operable communication with vehicles and/or mobiles devices of users that subscribe to an incentive program provided by the system, and the system 206 may receive information from the vehicles and/or mobile devices (e.g., via cellular connections and/or other data transfer systems) related to traffic flow, pollution levels, parking availability, etc. In still other embodiments, the system 206 may be part of the traffic authority 202 or comprise the traffic authority, and thus the network 204 may be a network internal to the traffic authority 202, for example. In still other embodiments, the traffic authority 202 may be software operating on the system 206 and thus the system 206 need not be operably coupled to the traffic authority 202 via the network 204.

In some embodiments, the system 206 may further and/or instead receive instructions from the traffic authority regarding when to provide incentives, a number of users to whom to provide incentives, and/or a type/amount of incentive to be provided. By way of example, in some embodiments, the traffic authority 202 is configured to determine a desired load reduction (e.g., a number of vehicles by which to reduce the present load on the route and/or expected future load) based upon information acquired from monitoring the route and to transmit a request to the system 206 via the network 204. The request includes a request for the system 206 to attempt to reduce the present load or expected future load on the route by the desired load reduction. By way of example, at 3 p.m., the traffic authority 202 may determine that the expected load on the route between 5 p.m. and 6 p.m. is likely to exceed capacity and create congestion and/or the expected load is likely to create an unsafe smog level. Accordingly, the traffic authority 202 may determine a desired load reduction that will reduce the expected load to less than or equal to capacity and/or less than or equal to a level desired to reduce smog to a safe level and may transmit a request, including the desired load reduction, to the system 206. In other embodiments, the traffic authority 202 may transmit, via the network 204, a request that comprises instructions on a number of offers to communicate, a starting offer (e.g., associated with a low valued reward), and/or instructions regarding how/when to alter the reward (e.g., in an attempt to interest additional users). In still other embodiments, a determination regarding when to provide incentives, a number of users to whom to provide incentives, and/or a type/amount of incentive, for example, may be determined by the system 206 based upon information known to the system 206 regarding present and/or expected future traffic flow.

The system 206 is configured to determine a desired number of users to whom to communicate the offer and/or identify candidates for the offer based upon the information provided by the traffic authority 202 and/or the determinations made by the system 206. In some embodiments, the system 206 identifies the candidates based upon information known to the system 206 regarding individual users. As an example, the traffic authority 202 may request that the system 206 attempt to decrease a load along a route (e.g., such as between mile-markers 20-25 of a highway) by 200 vehicles (e.g., the desired load reduction) between 5 pm and 6 pm tonight (e.g. a specified time window). Using this information, the system 206 may determine that 300 candidates for the offer should be identified (e.g., to achieve the 200 vehicle reduction) and may proceed to identify users that have a high probability of traveling the route as candidates for the offer. Such an identification of possible candidates may be based upon, among other things, driving habits of respective users and/or user specified information. For example, in some embodiments, a user may specify a route and time that the user intends to travel between home and work and, based upon this information, the system 206 may evaluate whether the user is a candidate for the offer. It is to be appreciated that a variety of techniques for identifying candidates are contemplated herein.

In some embodiments, the system 206 may take into consideration other factors (e.g., besides a likelihood that a user will travel the route during the specified time window) when identifying candidates for the offer. By way of example, for respective users that travel the route, the system 206 may further evaluate whether one or more alternate routes exists for the user, such as based upon positional and/or other information (e.g., speed information) provided by devices configured to communicate with the system 206, such as one or more recipient devices 210 associated with the user, for example. Users that have an alternate route available may be more likely to accept an offer than users that do not have an alternate route available and/or that merely have available an alternate route that adds significant time and/or distance to the commute. In this way, the system 206 may identify candidates as users that are likely to travel the route (e.g., unless an incentive is provided to avoid the route) and are able to take a different route without incurring a substantial cost (e.g., and thus may accept the offer when a lower valued reward is provided). As other examples, the system 206 may evaluate users to identify candidates based upon, among other things, information in the profile that indicates that the travel time of the user is flexible (e.g., the user can travel the route earlier or later during a less congested period) and/or a history of accepted offers (e.g., such that users who accept offers frequently are ranked higher than users that do not typically accept offers). In still other embodiments, the incentive may be provided to all users and/or all users known to be located within a specified geographic region of the route, for example. In yet other embodiments, a type of vehicle a user is driving may be considering when identifying users to whom to provide the offer. For example, large trucks and/or late model vehicles may generate more pollution than newer model vehicles and/or hybrid vehicles. Accordingly, offering an incentive to drivers of trucks and/or late model vehicles may reduce pollution along a route more substantially than an offer provided to drivers of newer vehicles. As another example, large trucks and/or full size vehicles may consume a greater amount of parking space and thus it may be desirable to divert such vehicles from areas where parking is limited.

The system 206 is also configured to create an offer and to communicate the offer to one or more users (e.g. the identified candidates) via a communication device 208, which is configured to transmit the offer to recipient devices 210. The offer typically requests that a user avoid a specified route during a specified time window and offers a reward in exchange for avoiding the route during the specified time window. In some embodiments, a same offer is communicated to a plurality of (e.g., all) identified candidates. In other embodiments, a first offer may be communicated to a first candidate and a second offer may be communicated to a second candidate, where the first offer and the second offer may differ by reward, for example (e.g., because an alternate route for the first candidate may add substantially more time to the first candidate's commute as compared to an alternate route for the second candidate). Moreover, in some embodiments, the offer provides an alternate route that the user must take during the specified time window to claim the reward and/or may optionally take to avoid the route. The alternate route may be tailored specifically to the user based upon information known about the user (e.g., such as starting and/or ending location) and/or may be a suggested detour that is provided to all candidates of the offer.

The recipient devices 210 may include vehicles, mobile phones, tablets, laptop and desktop computers, media devices, two-way radios, navigation devices, toll tags, and/or other electronic devices capable of communicating with the communication device 208 and configured to present the offer to a user. For example, the user may be presented as a visual or voice alert provided via a smartphone (e.g., through a user application), an in-vehicle head-unit, glasses worn by the user and configured to display information and/or via a projection onto a vehicle window, an e-mail or text alert, etc.

When an offer is accepted by a user, a recipient device associated with the user is configured to transmit an indication of the acceptance back to the system 206. The system 206 is configured to track the number of acceptances and, in some embodiments, is configured to update the offer presented to one or more users based upon the number of acceptances. By way of example, when a reward of 100 points was offered to avoid a route, 50 users may have accepted the offer. If more than 50 users are needed to achieve a desired load reduction, the system 206 may increase the reward to 200 points to incentivize additional users to accept the offer. In other embodiments, the system 206 may adjust a reward downward (e.g., decreasing the monetary value of the reward) as the number of users that accept an offer to avoid the route increases. In still other embodiments, the system 206 may increase a number of candidates to whom offers are provided in an effort to increase the number of acceptances, to further reduce the load on the route, etc.

In some embodiments, the system 206 is in (real-time) communication with the traffic authority 202 via the network 204. In this way, the traffic authority 202 may receive information regarding a number of users that have accepted the reward being offered, etc. Moreover, in some embodiments, the traffic authority 202 may dictate when and/or if to adjust a monetary value of the reward and/or may request a change to the desired load reduction. For example, the traffic authority 202 may initially request that the system 206 reduce the expected load by 200 vehicles. However, the traffic authority 202 may later revise the request to 100 vehicles, for example, based upon updated models indicating that the load on a route is expected to be less than previously forecasted and/or because the reward necessary to entice 200 users or more to accept the offer may be greater than the traffic authority 202 desires to spend, for example. As another example, the traffic authority 202 may initially indicate that diversion of 200 vehicles will achieve a desired reduction in pollution levels along a route. However, based upon changes in weather patterns, types of vehicles traveling along the route, etc. the traffic authority may revise the vehicle number to account for such changes. Accordingly, the system 206 and traffic authority 202 may exchange updates periodically and/or intermittently during a period in which the offer is outstanding to adjust the offer, adjust a number of users to whom the offer is communicated, and/or adjust a number of permissible acceptances, for example.

The system 206 may be further configured to monitor or track movement of the users during the specified time window to verify that the users avoided the route during the specified time window as agreed upon when the users accepted the offer(s). For example, the recipient devices 210 may communicate position information (e.g., such as acquired from GPS, cellular tower triangulation, toll tags, etc.) to the communication device 208. If the system 206 is able to verify that a user that accepted the offer avoided the route during the specified time window, the system 206 may provide the agreed upon reward to the user. If the system 206 determines that a user did not avoid the route during the specified time window (e.g., and thus did not satisfy the offer), the system 206 may withhold the reward from the user, for example.

Accordingly, in the example environment, the system 206 is tasked with at least one of managing offers, communicating the offers to users, tracking the acceptance of offers, monitoring the movement of users that have accepted an offer, or distributing a reward to those who comply with the offer and avoid the route specified in the offer during the specified time window, among other things. In other embodiments, one or more of these tasks may be performed by a system that is distinct from the example system 206. For example, a second system may be responsible for monitoring the movement of one or more users.

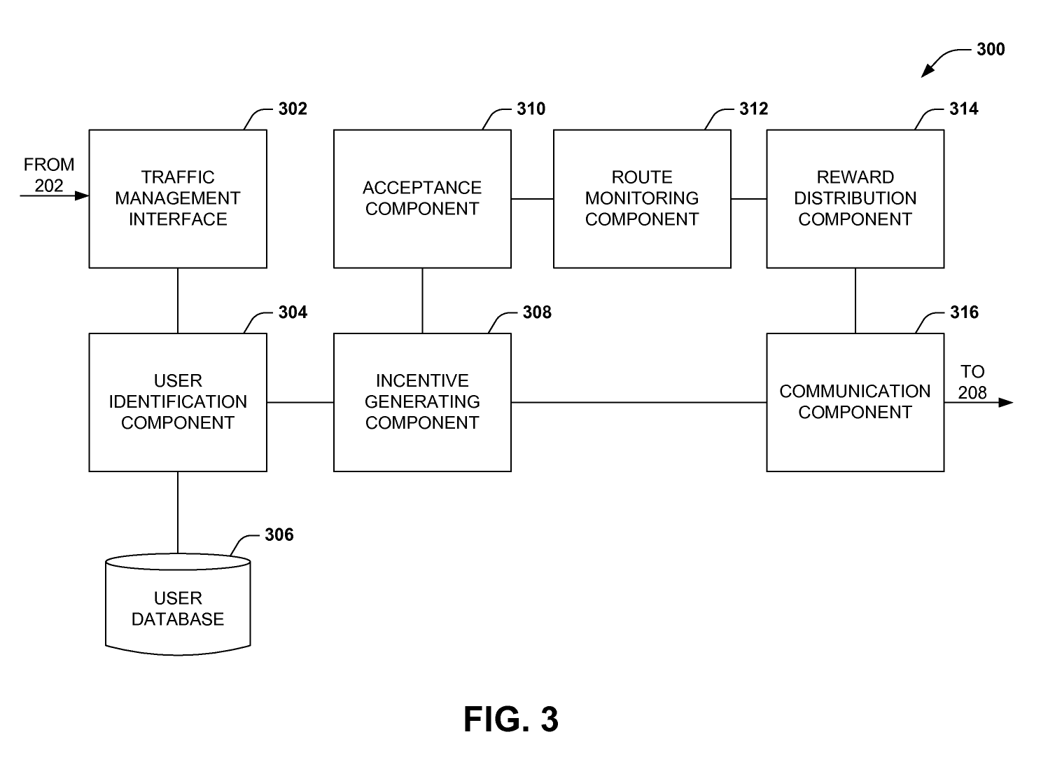

FIG. 3 illustrates an example environment 300 of an example system (e.g., 206 in FIG. 2) configured to manage offers, communicate offers to users, track the acceptance of offers, monitor the movement of users that have accepted an offer, and distribute a reward to those who comply with the offer. The example system comprises a traffic management interface 302, a user identification component 304, a user database 306, an incentive generating component 308, an acceptance component 310, a route monitoring component 312, a reward distribution component 314, and a communication component 316.

The traffic management interface 302 is operably coupled to a traffic authority (e.g., 202 in FIG. 2) and is configured to interface with the traffic authority to receive information from the traffic authority, such as requests to reduce a load along a route. By way of example, in some embodiments, the traffic management interface 302 is configured to receive information related to a desired load reduction for a route during a specified time window. In other embodiments, the traffic management interface 302 is configured to receive information related to a desired number of offers to communicate and/or a desired reward to offer users in exchange for avoiding the route during the specified time window. In still other embodiments, at noted above, the system may be configured to determine/model traffic conditions without the aid of the traffic authority, may be configured to act as the traffic authority, and/or may be configured to supplement information provided by the traffic authority. Accordingly, in embodiments where the system is configured to receive traffic information directly from reporting devices (e.g., 104 in FIG. 1), such as vehicles, mobile devices, dedicated traffic sensors, etc., the system may further comprise a traffic component, pollution component, parking component, etc. configured to receive such information/data, determine/model traffic volume, pollution levels, parking availability, etc. from the information (e.g., which may be supplemented with information provided by the traffic authority if such information is provided), etc.

The traffic management interface 302 is further configured to communicate information to the traffic authority, such as a number of acceptances, types of offer(s) pending, number of rewards distributed, etc. In this way, the traffic authority is made aware of how many users are agreeing to avoid a route, a cost associated with getting the users to agree, etc.

The user identification component 304 is configured to identify one or more users (e.g., candidates) to whom to communicate an offer to facilitate reducing traffic along the route by the desired load reduction. By way of example, in some embodiments, the system may provide entities with an opportunity to create an account and/or to opt into such an incentive-based program. Entities that create an account and/or opt into such a program may be identified as potential candidates for offering incentives to create a pool of users. From this pool, the user identification component 304 may identify users that are likely to travel the route during the specified time window, are likely to have an alternate route available to avoid traveling the route during the specified time window, etc. to identify candidates for a specific offer or set of offers, and/or are likely to have flexible travel times (e.g., and thus could travel the route during a less congested period), for example.

By way of example, in some embodiments, a user database 306 is maintained by the system. The user database 306 comprises a profile of respective users describing their travel habits. Such a profile may be user created and/or maybe automatically populated/supplemented based upon prior driving habits of the user. By way of example, in some embodiments, the user inputs his/her home address and work address, along with times that the user typically travels from work to home. From this information, the user identification component 304 may determine which route(s) the user is likely to take between home and work, for example. In other embodiments, user profiles may be created automatically based upon data that has been recorded related to respective users' driving habits. By way of example, a user may subscribe to a traffic monitoring service that provides route information (e.g., such as navigation information) and/or traffic information to a user. The traffic monitoring service may track the user's movement while the service is activated on the user's device. Data related to the user's movement may be compiled to create a profile of the user that describes peak travel time, frequently travelled routes, etc., which may be stored in the user database 306. Similarly, license plates may be read, usage of prepaid toll accounts or passes may be monitored, etc. to ascertain driving habits, for example.

When the user identification component 304 receives a request to identify users (e.g., candidates) for an offer, the user identification component 304 may review one or more user profiles stored in the user database 306 to identify users that meet criteria specified in the request. For example, the user identification component 304 may review the user profiles to identify, as candidates, one or more users that frequently travel the route during the time window specified in the request. In this way, the user identification component 304 selects, from the pool of users in the user database 306, candidates who have a highest probability of traveling the route during the specified time window.

In some embodiments, the user identification component 304 is further configured to identify candidates and/or rank the users based upon additional factors to identify candidates. For example, the user identification component 304 may determine whether respective users that travel the route have an alternate route available. Those users that have an alternate route available may be ranked higher than users that do not have an alternate route available (e.g., even though a user with no alternate route available may be more likely to travel the route during the specified time window). Further, the user identification component 304 may be configured to rank users that have an alternate route available which imposes little to no cost on the user (e.g., where cost may be a time cost, mileage cost, etc.) higher than users that have an alternate route available which imposes a higher cost on the user. As another example, the user identification component 304 may give preference to those users that have previously accepted similar offers and/or users that have followed through on an offer (e.g., to gain a reward) over users that have not accepted and/or followed through with offers in the past. As still other examples, the user identification component 304 may consider the type of vehicle the user drives, the likelihood that the user is intending to park along a route with limited parking availability (e.g., based upon prior parking habits of the user as indicated by present travel/navigation information, past driving habits, data regarding parking tags that grant access to park in a particular parking lot and/or parking meter, etc.). In this way, a group of candidates that have a higher probability of accepting the offer when a relatively small reward is offered are identified and/or that are likely to make a larger impact on a metric being observed (e.g., congestion, pollution, parking availability, etc.).

The incentive generating component 308 is configured to generate one or more offers to be communicated to the candidates identified by the user identification component 304. By way of example, the incentive generating component 308 is configured to set an initial reward for the offer. In some embodiments, the initial reward may be the same for respective users identified by the user identification component 304. In other embodiments, an initial reward for an offer communicated to a first user may be different than an initial reward for an offer communicated to a second user. For example, the reward offered to the second user may be of a higher monetary value than the reward offered to the first user if the cost a second user bears for taking an alternate route is greater than a cost the first user bears for taking an alternate route (e.g., because the alternate route of the first user may add merely a mile to his/her commute whereas an alternate route of the second user may add 5 miles to his/her commute). As another example, the first user may be offered a higher reward than the second user because it is believed the first user will have a greater impact on the metric being monitored (e.g., and thus the offer can be provided to fewer users and/or a number of acceptances needed to achieve a desired result may be reduced). The initial reward may be determined arbitrarily, may be specified by the traffic authority, and/or may be determined based upon a history regarding the type(s) of offers that typically incentivize users for a particular route and/or incentivize users within a particular geographic area, for example.

One or more offers generated by the incentive generating component 308 may be transmitted to the communication component 316, configured to communicate the offer(s) to identified users (e.g., candidates) via a communication device (e.g., 208 in FIG. 2).

The incentive generating component 308 is further in operable communication with the acceptance component 310. The acceptance component 310 is configured to receive an indication when a user accepts an offer and to track a number of users that accept offers to avoid a route during a specified period of time. By way of example, in some embodiments, a communication device (e.g., 208 in FIG. 2) communicates an acceptance or indication thereof to the acceptance component 310 when a user accepts an offer via a recipient device (e.g., 210 in FIG. 2).

Based upon a number of acceptances to the offer(s) that have been received by the acceptance component 310 (e.g., and/or the types of users that have accepted—such as categorized by a type of vehicle the user is likely driving), the incentive generating component 308 is configured to periodically and/or intermittently adjust a reward associated with the offer (e.g., until the number of accepted offers satisfies the desired load reduction for the route). In some embodiments, when the acceptance component 310 indicates that fewer users have accepted an offer than is needed to satisfy the desired load reduction, the incentive generating component 308 may adjust one or more offers pertaining to the route to encourage additional users to accept an offer and avoid the route during the specified time window. By way of example, if the acceptance component 310 indicates that merely 50 users have accepted an offer to avoid the route during the specified time window and a load reduction of 100 cars is desired, the incentive generating component 308 may increase the monetary value of the reward (e.g., by the same or differing amounts to different users) to encourage additional users to accept the offer and request that the communication component 316 deliver the updated offer, with the increased reward, to users that have not already accepted an offer (e.g., where these users may be the same or at least some different users to whom the initial/previous offer was offered). As another example, when the offer triggers a rapid influx of acceptances, the incentive generating component 308 may reduce the reward to slow a rate of acceptance (e.g., because a reward that was offered initially might have been higher than necessary to satisfy the desired load reduction and a lower reward might still achieve the desired load reduction).

When the acceptance component 310 indicates that the number of acceptances is sufficient to satisfy the desired load reduction, the incentive generating component 308 may be configured to revoke one or more outstanding offers pertaining to the route. Accordingly, the communication component 316 may generate a notice to revoke an offer from a user prior to the user accepting the offer and/or may generate a notice to other users (such as those who accepted, those who did not accept, and/or those who were not provided an offer) that the desired acceptance threshold has been met (e.g., to generate further interest in the incentive program and/or increase participation in the program). It may be appreciated that, in some embodiments, the number of acceptances that are sufficient to satisfy the desired load may be greater than the desired load reduction. For example, 250 acceptances may be necessary to achieve a load reduction of 200 vehicles due to some users accepting the offer and not fulfilling the terms of the offer (e.g., such as by traveling the route during the specified time window). Thus, in some embodiments, the incentive generating component 308 is configured to set an acceptance threshold that exceeds the desired load reduction to facilitate satisfying the desired load reduction. In some embodiment, the incentive generating component 308 is configured to set the acceptance threshold based upon prior knowledge regarding a ratio of the number of users that accept offers and the number of users that fulfilled the accepted offer, for example. By way of example, from prior experience, it may be estimated that 250 users have to accept the offer to achieve a load reduction of 200 vehicles (e.g., because 20% of users typically accept an offer and then fail to fulfill the offer). In other embodiments, the travel of users that have accepted the offer is tracked such that the number of acceptances does not have to be statistically inflated.

The acceptance component 310 is also operably coupled to a route monitoring component 312 configured to monitor movement of users that have respectively accepted an offer. By way of example, in some embodiments, recipient devices and/or other devices associated with respective users are configured to transmit position information, such as GPS coordinates, accelerator information, directional information, street names, etc. to a communication device (e.g., 208 in FIG. 2) operably coupled to the route monitoring component 312. The position information may be communicated to the route monitoring component 312 in real-time during the specified time window when the user is to avoid the route and/or at a later time (e.g., such as when a user connects the recipient device to an internet network). If the route monitoring component 312 determines that a user indeed avoided the route during the specified time window, the route monitoring component 312 may be configured to notify a reward distribution component 314 to provide an agreed upon reward (e.g., as indicated in the accepted offer). If the route monitoring component 312 determines that a user traveled the route during the specified time window, instead of taking an alternate route, the route monitoring component 312 may be configured to notify the reward distribution component 314 to not provide the reward or to potentially even provide a “negative” reward to discourage users from attempting to game the system (e.g., such as by deducting points or other rewards the user has previously been awarded). In this way, the route monitoring component 312 verifies that the user performed as agreed upon in the offer and is thus entitled to the reward.

The reward distribution component 314 is configured to provide the reward to a user upon the route monitoring component 312 verifying that the user complied with the offer. By way of example, in some embodiments, the user maintains an account with the system and the reward may be applied to the account. In other embodiments, the user may link an external account to the system and the reward may be applied to the external account by way of the reward distribution component 314. In still other embodiments, the reward distribution component 314 may mail, email, or otherwise deliver the reward to the user.

The reward may include, among other things, money, gift cards, points to be applied towards gift cards, goods, services, etc., rebates, such as rebates on licensing fees, tolls, and/or merchandise, coupons valid towards purchases at select merchants, etc. Typically, the reward has at least some monetary value. For example, 500 points may be cashed in for 5 dollars, and thus 500 points is equivalent to 5 dollars. Likewise, a 10% off coupon to a store may be worth less monetarily than a 25% off coupon to the same store. Accordingly, adjusting a monetary value of a reward by the incentive generating component 308 may comprise adjusting a number of points, a percentage off, etc.

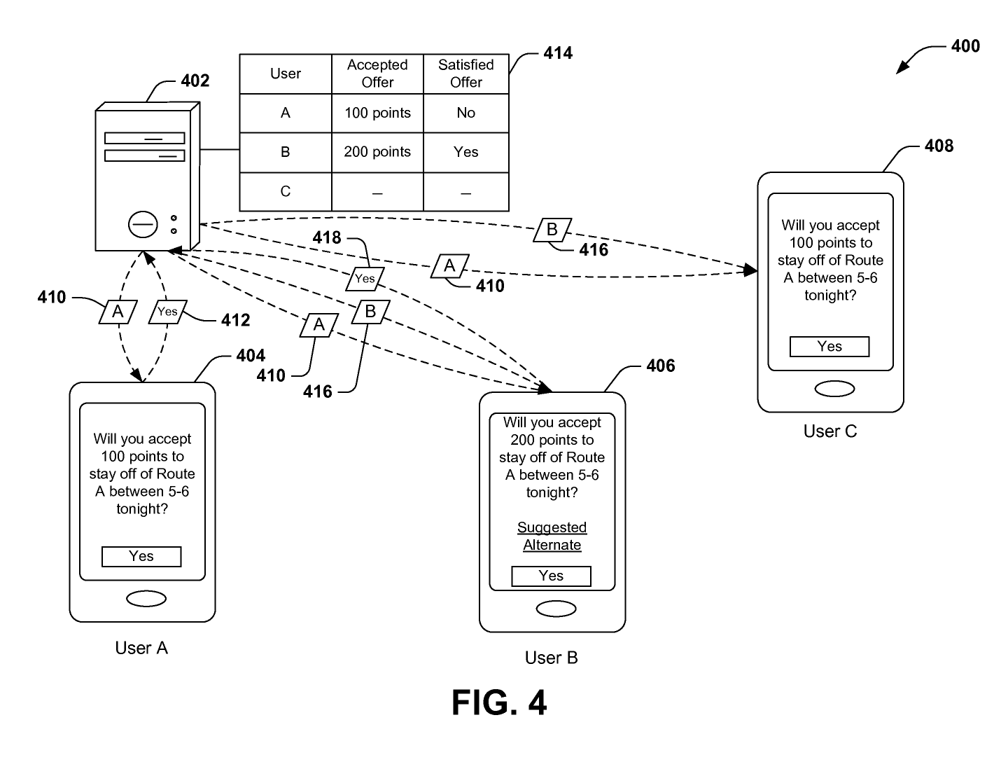

FIG. 4 illustrates an example environment 400 further describing how one or more users, such as User A, User B, and User C may be incentivized to avoid a route such as via a traffic management system 402 (e.g., 300 in FIG. 3). For this example, it is presumed that the system 402 has already determined that Users A, B, and C are candidates for a particular offer based upon the route the offer pertains to, the time window when the load reduction is desired, and/or the availability of alternate routes for respective Users A, B, and C. In this example, the users are respectively associated with a recipient device, such as a smartphone, configured to communicate messages and/or offers to the user. For example, User A is associated with a first recipient device 404, User B is associated with a second recipient device 406, and User C is associated with a third recipient device 408. It may be appreciated that while the example illustrates a single recipient device per user, respective users may be associated with one or more devices and the offer may be provided to a limited subset of such devices and/or all devices (e.g., cell phone and tablet, but not desktop). Moreover, the user may accept the offer on a first device and movement of the user may be monitored via a second device associated with the user.

Initially, a first offer 410 pertaining to the route, labeled “A,” may be provided to respective recipient devices 404, 406, and 408. The first offer 410 may be communicated to respective recipient devices 404, 406, and 408 via cellular, Wi-Fi, LAN, WLAN, SMS, and/or in any other manner.

As illustrated on a display of the first recipient device 404, the offer may ask the user if the user is willing to accept 100 points (e.g., redeemable for gift cards, coupons, rebates, etc.) in exchange for avoiding route A between 5 pm and 6 pm tonight. Although not illustrated, in some embodiments, the first offer 410 may further comprise a map or other indicia illustrating/describing precisely which road, or portion of the road, the user is to avoid in order to receive the 100 points.

If a user accepts the offer, such as by selecting a “Yes” button, and/or replying to the offer, the system 402 may record the acceptance. For example, User A may accept the first offer 410 and an indication 412 of the acceptance of the first offer 410 by User A may be recorded by the system 402. For example, a table 414 may be maintained such as by an acceptance component (e.g., 310 in FIG. 3) identifying respective users to whom an offer was communicated and whether respective users have accepted an offer. For users that accepted an offer, the value of the reward at the time the user accepted the offer may also be listed. By way of example, User A accepted the first offer, which provided 100 points in exchange for avoiding the route during the specified time window. Accordingly, the table 414 lists that user A accepted an offer of 100 points in exchange for avoiding the route during the specified time window.

If a sufficient number of users do not accept the first offer 410, the offer may be updated or a second offer 416, labeled “B,” may be generated by the system 402 and communicated to one or more users (e.g., those users that did not accept the first offer). By way of example, the second offer 416 may be communicated to the second recipient device 406, associated with User B, and to the third recipient device 408, associated with User C, because neither User B nor User C accepted the first offer 410. In some embodiments, the second offer 416 is not communicated to the first recipient device 404 because User A accepted the first offer 410.

The second offer 416 may be indicative of a reward that is different than the reward offered by the first offer 410. By way of example, the second offer 416 may be indicative of a higher valued award to entice additional users to accept an offer to avoid the route during the specified time window. For example, in the illustrated embodiment with regard to the second recipient device 406, the second offer 416 may offer a reward of 200 points, whereas the first offer 410 offered merely 100 points to avoid the route.

As illustrated on a display of the second recipient device 406, the offer may ask the user if the user is willing to accept 200 points (e.g., redeemable for gift cards, coupons, rebates, etc.) in exchange for avoiding route A between 5 pm and 6 pm tonight.

Further, in some embodiments, one or more of the offers may include a suggested alternate route for the user or a group of users to whom offers are sent. By way of example, the second offer 416 may comprise a “suggested alternate” hyperlink, where the hyperlink points to a page describing one or more alternate routes to avoid the route to which the offer pertains. The alternate route may be a user-specific alternate route (e.g., describing an alternate route for the user to travel between work and home), or may be user-neutral. For example, in some embodiments, the alternate route may provide one or more detours for avoiding the route the offer pertains to without specifically detailing a route that any one user may take from his/her present location to wherever he/she is traveling. In some embodiments, the displayed route further includes an estimated travel time (e.g., which may, in some embodiments, be less than expected travel time for the user if the user were to take the route).

In other embodiments, the offer may include an alternate route that the user or a group of users are required to travel in order to claim the reward. For example, a traffic authority may desire to shift traffic from a first highway to a second highway the runs substantially parallel to the first highway. Accordingly, the offer may provide that a user must travel the second highway during the specified time window to claim the reward. In such embodiments, users who do not travel the second highway during the specified time window may not be eligible claim the reward even though they avoided the first highway. In other embodiments, the reward may be claimed even if the user takes a route that is not suggested, travels along the route prior to the specified time window (e.g., by leaving work early), or postpones his/her travel until after the specified time window so that he/she can take the route while still claiming the reward (e.g., by leaving work later).

If a user accepts the second offer 416, the acceptance is recorded in the table 414. For example, in the illustrated embodiment, the second user accepts the second offer 416 and an indication 418 of the acceptance is transmitted from the second recipient device 406 to the system 402 for recordation.

When a desired number of offers have been accepted and/or a time limit for accepting offers has expired (e.g., where it may be too late to affect congestion along the route during the specified time window), outstanding offers may be revoked. For example, User C may not have accepted either the first offer 410 or the second offer 416 prior to the desired number of offers having been accepted and/or the time limit expiring. Accordingly, offers communicated to the third recipient device 408 may be revoked and User C may not be able to take advantage of the offer to receive points.

The system 402 may be further configured to monitor, during the specified time window, the movement of users that accept the offer to verify that the users avoided the route. Users that satisfy the offer (e.g., by avoiding the route during the specified time window, commuting a mandated alternate route, etc.) may be provided with the reward that was offered to the user, and users that did not satisfy the reward may not be provided with the reward. For example, the table 414 provides that User B satisfied the offer by avoiding the route during the specified time window, while User A did not. Accordingly, User B may be awarded the 200 points indicated in the offer User B accepted while User A may not be award the 100 points indicated in the offer User A accepted. User C may also not be awarded any points because User C did not accept an offer in time.

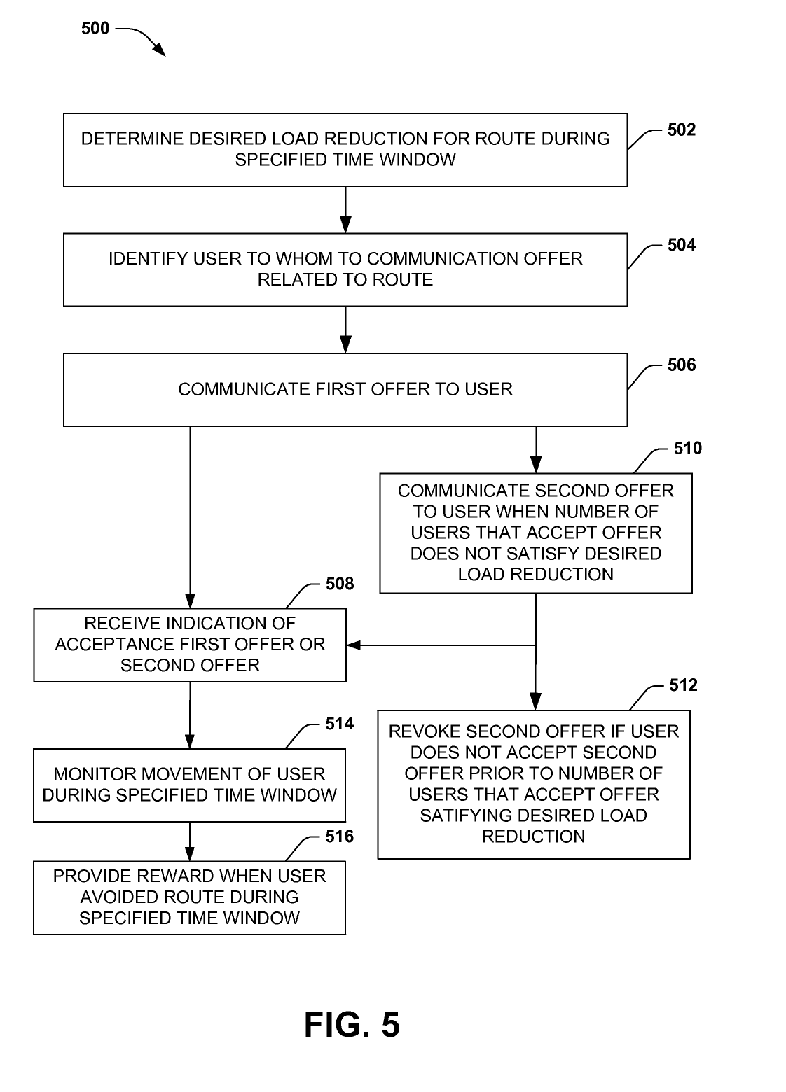

FIG. 5 illustrates a flow diagram of an example method 500 for traffic management wherein incentives are provided to one or more users to avoid a route during a specified time window (e.g., to reduce load or congestion along the route during the specified time window).

At 502 in the example method 500, a desired load reduction for the route during a specified time window is determined. By way of example, in some embodiments, a traffic system (e.g., 300 in FIG. 3) is configured to compare present load with present capacity. When the load is within a specified threshold of capacity, the traffic system may determine a desired load reduction that would reduce the present load on the route (e.g., below the specified threshold) to reduce congestion, to reduce pollution levels, and/or due to limited parking availability along the route, for example. In other embodiments, the traffic system is configured to model future loads with future capacity to identify instances where loads may be within a specified threshold of capacity, for example, and to determine desired load reductions during such instances. In still other embodiment, a traffic system may determine a desired load reduction from a request provided by a traffic authority (e.g., where the request is indicative of the desired load reduction).

At 504 in the example method 500, one or more users (e.g., a set of users) are identified to whom to communicate an offer related to the route. That is, stated differently, candidates for an offer are identified. Ideal candidates for an offer typically include users (e.g., drivers) that travel the route during the specified time window and/or users that have an alternate route available. Accordingly, identifying the one or more users may comprise identifying, from a pool of users, one or more users that have a high probability of traveling the route during the specified time window. By way of example, a database of users (e.g., such as a database of entities that have subscribed to a service to receive such offers) may comprise user profiles. Respective profiles may comprise information pertaining to a user's prior driving habits (e.g., which routes that user has taken and when the user typically takes such routes) and/or other information pertaining to the user (e.g., such as type(s) of vehicle(s) driven, expected route information received based upon user input—where the user specifies routes that he/she intends to travel and when he/she intends to travel such routes, etc.). Thus, the traffic system may review the profiles of users in the pool to identify users whose prior driving habits and/or user inputted information is indicative of a (e.g., high) probability that the user will travel the route during the specified time window, for example.

It may be appreciated that not all users of a route may have the option to travel an alternate route without incurring substantially cost (e.g., due to time differences, mileage differences, etc.). Accordingly, in some embodiments, identifying one or more users to whom to communicate an offer may comprise identifying, for respective users, whether an alternate route is available for the user during the specified time window. Users to whom an alternate route is available (e.g., that would allow the user to get from point A to point B without adding mileage in excess of a mileage threshold and/or time in excess of a time threshold) may be identified as candidates for the offer. Users to whom an alternate route is not available without exceeding a mileage threshold and/or time threshold, for example, may not be identified as candidates for the offer. Determining whether an alternate route(s) are available for respective users may be based upon the profile of the user, including prior driving habits and/or user inputted information (e.g., such as a home and work address), for example.

In other embodiments, users of a pool of users are ranked based upon, among other things, a probability that respective users will travel the route and/or an availability of an alternate route. The top “X” users may be identified as candidates for the offer, where “X” is equal to a number of users to whom it is desirable to communicate the offer to promote the desired load reduction

At 506, a first offer is communicated to a user or set of users identified at 504. The offer is indicative of a reward provided to the user or set of users in return for avoiding the route during the specified time window. A same offer may be provided to a plurality of user candidates and/or an offer communicated to a first user may be different than an offer communicated to a second user. For example, a first user may be offered 100 points for avoiding a route and a second user may be offered 200 points for avoiding the route (e.g., due to an alternate route for the second user being more costly than an alternate route for the first user). In another example, the same reward is offered to the first user and the second user regardless of alternate route considerations, for example.

In some embodiments, the first offer describes an alternate route that the user or set of users are required to take or are suggested to take to avoid the route. Where the first offer mandates that the user take the alternate route during the specified time window, the user can receive the reward if the user takes the alternate route. When the first offer suggests that the user take the alternate route, the user can receive the reward even if the user takes a different route and/or travels the route at a time not included in the specified time window, for example. The alternate route may be user-specific (e.g., describing a specific route for the user to travel to get from home or work) or may be user-neutral (e.g., describing a detour for avoiding the route without necessarily navigating a user from his/her starting point to ending point).

The first offer may be communicated to devices, such as mobile phones, laptops, vehicles, etc. associated with users to whom the offer applies via email, text messaging, application pop-up notifications, and/or other communication channels/mediums. The communicated first offer includes the terms of the offer, such as the route the user is to avoid and the window of time in which the user is to avoid the route. The communicated first offer further is indicative of the reward that will be provided to the user in exchange for the user avoiding the route during the specified time window.

The first offer is typically transmitted merely to one or more users identified as candidates at 504 (e.g., selected from the pool of possible candidates). Accordingly, where alternate routes are taken into consideration when identifying candidates, the offer may be communicated to a user responsive to determining that an alternate route is available for the user, and the offer (e.g., or a second offer pertaining to the route) may not be communicated to a second user responsive to determining that an alternate route is not available for the second user, for example.

The offer may further include information pertaining to a number of users to whom an offer(s) is communicated, a number of users that have already accepted the offer (e.g., where the offer may be updated in real-time based upon acceptances by other users), timing remaining to accept the offer, etc. By way of example, in an embodiment, the offer indicates that there is a finite number of rewards available to a pool of users (e.g., to whom offers were communicated). The offer may also or alternatively indicate the remaining number of outstanding/unaccepted offers and/or corresponding rewards available. In other embodiments, the number of rewards available may be not be finite, but the value of the reward may decrease over time based upon a number of accepts to discourage users from accepting the reward. In this way, a sense of urgency to accept the offer or lose out on the offer may be created, for example.

If a user accepts the first offer, an indication of the acceptance of the first offer is received at 508. For example, a reply email, text message, and/or other communication may be provided to a system managing the offer to indicate that a user has accepted the offer. In this way, a reward is reserved for the user if the user complies with the terms of the offer and avoids the route during the specified time window.

If the user does not accept the first offer within a desired time window and a number of users that accept the offer does not satisfy a desired load reduction (e.g., the number of users that accept the offer is less than an acceptance threshold), the first offer may be updated to communicate a second offer to the user and/or other users that have not yet accepted the offer at 510. For example, a monetary value of the reward may be increased (e.g., from 100 points to 200 points) to further incentivize users to accept the offer and avoid the route during the specified time window. The second offer may differ from the first offer in other ways as well. For example, the second offer may suggest an alternate route for the user whereas the first offer may not have made such a suggestion. Additionally and/or alternatively, the offer may be made to additional users, where the terms of the offer may be the same or different than the initial/previous offer (e.g., the offer may be offered to candidates who were previously screened out for not having a high enough probability of accepting the offer).

Although not illustrated in the example method 500, if the user does not accept the first offer before a number of other users that accept the offer or other similar offers satisfy the desired load reduction, the first offer may be revoked from the user. Similarly, outstanding offers communicated to one or more other users may be revoked prior to the other users respectively accepting the offer.

If the user accepts the second offer, an indication of the acceptance of the second offer is received at 508. If the user does not accept the second offer prior to the number of users that accept offers satisfying the desired load reduction, the second offer is revoked at 512 (e.g., and the user loses out on the opportunity to accept an offer and potentially claim a reward).

At 514 in the example method 500, the movement of the user, during the specified time window is monitored if the user accepted that first offer or the second offer. For example, one or more devices associated with the user, such as a cellular telephone, vehicle, bar code regarding prepaid tolls that may be read as the user passes through toll booths, etc. may record positional information such as GPS information, accelerator information, cell tower information, etc. to determine a whereabouts of the user during the specified time window. In this way, the system may determine whether the user avoided the route (e.g., and took the alternate route if required) during the specified time window, for example.

At 516 in the example method 500, a reward is provided to the user if the user accepted the offer and avoided the route during the specified time window. The reward that is provided to the user is a function of the reward that was offered in the accepted offer. For example, if the user accepted the first offer, which may have been indicative of a 100 point reward, the user may be provided 100 points. If the user accepted the second offer, which may have been indicative of a 200 point reward, the user may be provided 200 points. The reward may be provided to the user via an account created by the user to store points, credits, etc. earned from the system, via an account external to the system, via email, etc. Also, the reward may be graduated based upon a degree of compliance with the terms of the offer. For example, if the user did not immediately exit the route, but instead took a second, third, etc. exit or off ramp to exit the route (e.g., and thus travelled at least some of the route), the reward may be reduced by a certain amount (e.g., 20 percent). Similarly, if the user entered back onto the route, instead of staying off of the entire route (e.g., and thus travelled at least some of the route), the reward may be reduced. If the user merely avoided the route for some of the time window, then the reward may be reduced. For example, if the load was to be reduced from 5 pm to 6 pm, but the user travelled from 5:30 pm to 6:30 pm, the reward may be reduced (e.g., because the user's impact on load reduction was less than anticipated).

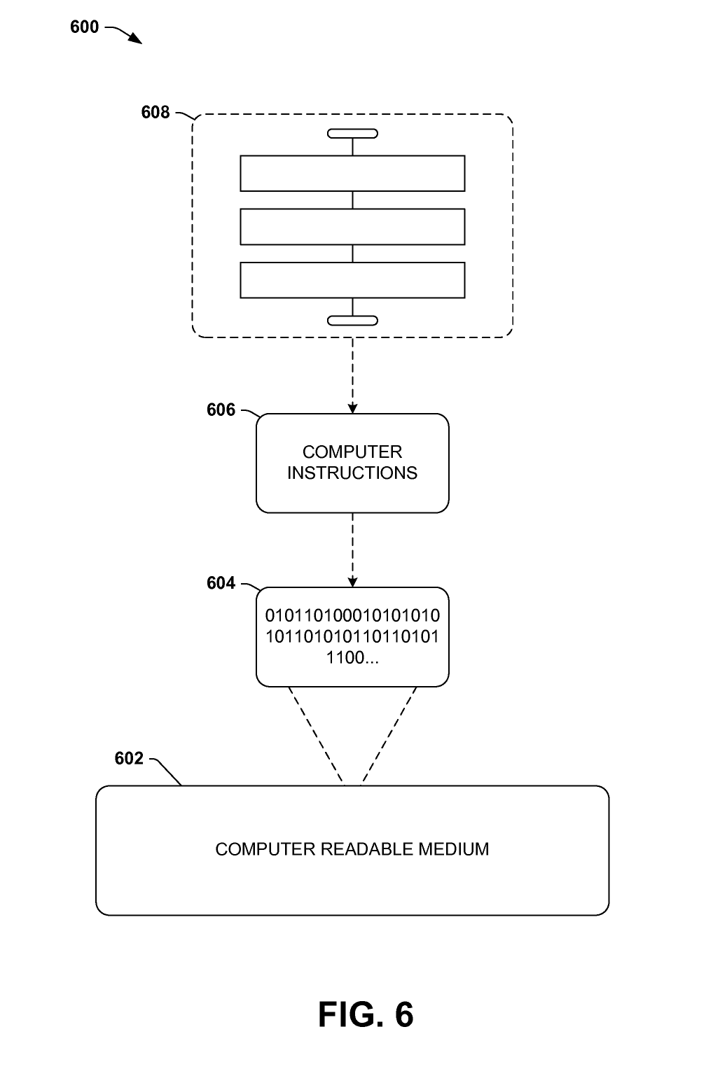

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 604. This computer-readable data 604 in turn comprises a set of computer instructions 606 configured to operate according to one or more of the principles set forth herein. In one such embodiment 600, the processor-executable computer instructions 606 may be configured to perform a method 608, such as at least some of the exemplary method 500 of FIG. 5, for example. In another such embodiment, the processor-executable instructions 606 may be configured to implement a system, such as at least some of the exemplary environment 100 of FIG. 1, at least some of the exemplary environment 200 of FIG. 2, and/or at least some of the exemplary system 300 of FIG. 3, for example. Many such computer-readable media 602 may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art may recognize many modifications may be made to this configuration without departing from the scope or spirit of the claimed subject matter.

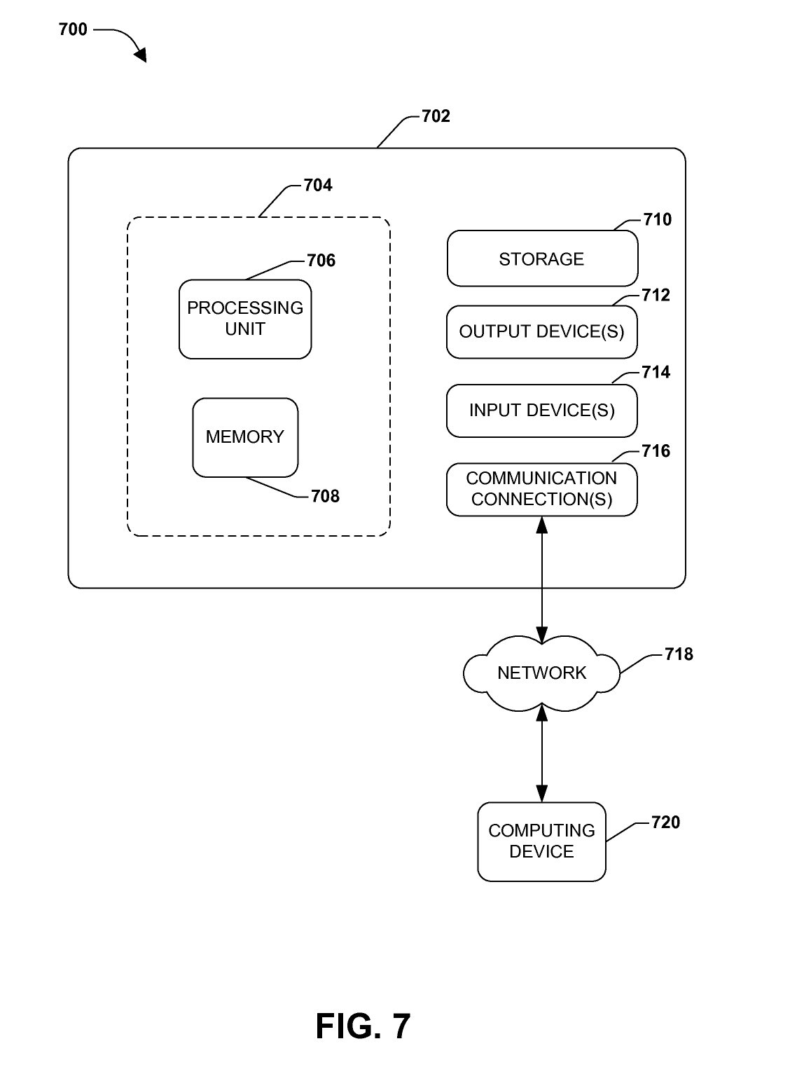

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 702 configured to implement one or more embodiments provided herein. In one configuration, computing device 702 includes at least one processing unit 706 and memory 708. Depending on the exact configuration and type of computing device, memory 708 may be volatile (such as RAM, for example), non-volatile (such as ROM, flash memory, etc., for example), or some combination of the two. This configuration is illustrated in FIG. 7 by dashed line 704.

In other embodiments, device 702 may include additional features and/or functionality. For example, device 702 may also include additional storage (e.g., removable and/or non-removable) including, but not limited to, magnetic storage, optical storage, and the like. Such additional storage is illustrated in FIG. 7 by storage 710. In an embodiment, computer readable instructions to implement one or more embodiments provided herein may be in storage 710. Storage 710 may also store other computer readable instructions to implement an operating system, an application program, and the like. Computer readable instructions may be loaded in memory 708 for execution by processing unit 706, for example.

The term “computer readable media” as used herein includes computer storage media. Computer storage media includes volatile and nonvolatile, removable and non-removable media implemented in any method or technology for storage of information such as computer readable instructions or other data. Memory 708 and storage 710 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 702. Any such computer storage media may be part of device 702.

Device 702 may also include communication connection(s) 716 that allows device 702 to communicate with other devices. Communication connection(s) 716 may include, but is not limited to, a modem, a Network Interface Card (NIC), an integrated network interface, a radio frequency transmitter/receiver, an infrared port, a USB connection, or other interfaces for connecting computing device 702 to other computing devices. Communication connection(s) 716 may include a wired connection or a wireless connection. Communication connection(s) 716 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 702 may include input device(s) 714 such as keyboard, mouse, pen, voice input device, touch input device, infrared cameras, video input devices, and/or any other input device. Output device(s) 712 such as one or more displays, speakers, printers, and/or any other output device may also be included in device 702. Input device(s) 714 and output device(s) 712 may be connected to device 702 via a wired connection, wireless connection, or any combination thereof. In an embodiment, an input device or an output device from another computing device may be used as input device(s) 714 or output device(s) 712 for computing device 702.

Components of computing device 702 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 702 may be interconnected by a network. For example, memory 708 may be comprised of multiple physical memory units located in different physical locations interconnected by a network.

Those skilled in the art may realize that storage devices utilized to store computer readable instructions may be distributed across a network. For example, a computing device 720 accessible via a network 718 may store computer readable instructions to implement one or more embodiments provided herein. Computing device 702 may access computing device 720 and download a part or all of the computer readable instructions for execution. Alternatively, computing device 702 may download pieces of the computer readable instructions, as needed, or some instructions may be executed at computing device 702 and some at computing device 720.

Various operations of embodiments are provided herein. In an embodiment, one or more of the operations described may constitute computer readable instructions stored on one or more computer readable media, which if executed by a computing device, may cause the computing device to perform the operations described. The order in which some or all of the operations are described should not be construed as to imply that these operations are necessarily order dependent. Alternative ordering may be appreciated by one skilled in the art having the benefit of this description. Further, it may be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B or the like generally means A or B or both A and B.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. (e.g., “a first channel and a second channel” generally corresponds to “channel A and channel B,” where channel A and channel B may be two different channels, two identical channels, and/or the same channel).

Although the disclosure has been shown and described with respect to one or more implementations, equivalent alterations and modifications may occur to others skilled in the art based at least in part upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for traffic management, comprising:
determining a desired load reduction for a route during a specified time window; and
communicating an offer to a user of the route to reduce traffic along the route to promote the desired load reduction, the offer indicative of a reward provided in return for avoiding the route during the specified time window.

2. The method of claim 1, comprising:
identifying the user, from a pool of users, based upon prior driving habits of the user, the prior driving habits indicative of a probability that the user will travel the route during the specified time window.

3. The method of claim 1, comprising:
identifying an alternate route for the user, and the offer requesting that the user travel the alternate route during the specified time window.

4. The method of claim 1, the communicating comprising:
communicating the offer to the user responsive to determining that an alternate route is available for the user.

5. The method of claim 1, comprising:
not communicating a second offer to a second user responsive to determining that a second alternate route is not available for the second user.

6. The method of claim 1, the communicating comprising:
communicating the offer to a pool of users that includes the user;
determining whether a number of users of the pool that have accepted the offer satisfies the desired load reduction; and
communicating a second offer to the user when the number of users that have accepted the offer does not satisfy the desired load reduction and when the user did not accept the offer, the second offer indicative of a second reward that is different than the reward.

7. The method of claim 1, comprising:
revoking the offer from the user, prior to acceptance of the offer by the user, when a number of accepted offers satisfies the desired load reduction.

8. The method of claim 1, comprising:
receiving an indication indicative of an acceptance of the offer by the user;
monitoring movement of the user during the specified time window responsive to the indication; and
providing the reward to the user when the movement indicates that the user avoided the route during the specified time window.

9. The method of claim 1, the offer indicating that there is a finite number of rewards available to a pool of users including the user.

10. The method of claim 9, the communicating comprising:
escalating a monetary value of the reward associated with the offer until a number of users that have accepted the offer is equal to the finite number of rewards.

11. A system for traffic management, comprising:
a user identification component configured to identify a user to whom to communicate an offer to facilitate reducing traffic along a route by a desired load reduction during a specified time window, the offer indicative of a reward provided in return for avoiding the route during the specified time window;
an incentive generating component configured to adjust the reward until a number of accepted offers satisfies the desired load reduction; and
a route monitoring component configured to monitor movement of the user during the specified time window if the user has accepted the offer to verify that the user has avoided the route.

12. The system of claim 11, the incentive generating component configured to revoke the offer when the number of accepted offers satisfies the desired load reduction prior to the user accepting the offer.

13. The system of claim 11, comprising a communication component configured to communicate the offer to the user.

14. The system of claim 11, comprising a traffic management interface configured to interface with a traffic authority to receive information related to the desired load reduction.

15. The system of claim 11, comprising a reward distribution component configured to provide the reward when the movement of the user indicates that the user avoided the route during the specified time window.

16. The system of claim 15, the reward distribution component configured to not provide the reward to the user when the movement of the user indicates that user traveled the route during the specified time window.

17. The system of claim 11, the user identification component configured to:
identify the user based upon a determination that an alternate route is available for the user.

18. The system of claim 11, comprising an acceptance component configured to receive an indication of an acceptance of the offer by the user.

19. A method for traffic management, comprising:
identifying a set of one or more users to whom to communication an offer;
communicating a first offer to the set, the first offer indicative of a first reward provided to respective users of the set in return for avoiding a route during a specified time window;
when a number of users of the set that accept the first offer is less than a desired threshold, communicating a second offer to users of the set that did not accept the first offer, the second offer indicative of a second reward, the second reward different than the first reward; and
revoking at least one of the first offer or the second offer when the desired threshold is met.

20. The method of claim 19, comprising:
providing the first reward to a user who accepted the first offer when the user avoids the route.
